(19) United States
(12) Patent Application Publication
(10) Pub. No.: US 2009/0138905 A1
(43) Pub. Date: May 28, 2009

(54) SYSTEM AND METHOD FOR SYNCHRONIZING PARENTAL CONTROL SETTINGS

(75) Inventors: Robert Blanchard, Escondido, CA (US); Mark Eyer, Woodinville, WA (US); Peter Shintani, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 11/945,780

(22) Filed: Nov. 27, 2007

(51) Int. Cl. H04N 7/16

(52) U.S. Cl. 725/25; 725/28; 725/27; 715/719; 725/139

(57) ABSTRACT

Parental control settings are provided to a display device by a user. In one embodiment, the display device generates a message, such as a consumer electronic control (CEC) message, which corresponds to the user-provided parental control settings. This message may then be transmitted to one or more source devices to which the display device is connected via an HDMI interface. The HDMI-connected devices may then modify or otherwise conform their own parental control settings in accordance with the parent control data in the received message. In one embodiment, the display device may then receive content from the HDMI-connected devices which has already been pre-filtered in accordance with the parental control settings that were provided directly to the display device.

### FIELD OF THE INVENTION

The present invention relates in general to synchronizing settings, and in particular to synchronizing such settings across a plurality of HDMI-connected devices.

### BACKGROUND

Parental control has been used to provide television viewers with the ability to regulate viewing based on the suitability of a television program for children and/or adults. While the process of rating programming differs greatly from one country to another, programs are generally rated by either the organization that manages the system, the broadcaster, or by the content producers themselves. For example, the Motion Picture Association of America (MPAA) has a film rating system used in the United States and its territories to rate a movie's suitability for certain audiences. The various MPAA rating levels include: G (General Audiences—all ages admitted); PG (Parental guidance suggested—some material may not be suitable for young children); PG-13 (Parents strongly cautioned—some material may be inappropriate for children under 13); R (Restricted—under 17 requires accompanying adult; and NC-17 (No one 17 or under admitted). When movies are broadcast on television, the MPAA rating often accompanies the movie content, allowing a parent to, for example, prevent viewing on a given TV receiver of movies rated R or higher.

Similarly, the TV Parental Guidelines system went into effect in 1997 on most major broadcast and cable networks in response to public concerns of increasingly explicit sexual content, graphic violence and strong profanity in television programs. It was established as a voluntary-participation system, with ratings to be determined by the individually-participating broadcast and cable networks. The various ratings provided for under the TV Parental Guidelines include TV-Y (Suitable for all ages); TV-Y7 (Unsuitable for very young children); TV-Y7-FV (may not be suitable for young children under 7—contains fantasy violence); TV-G (general audience); TV-PG (Unsuitable for young children); TV-14 (Suitable for older children); and TV-MA (intended for mature audiences). As with movies, parents may set up a television receiver to block programming carrying certain rating TV Parental Guideline levels.

In the case of an NTSC composite video, S-Video or 480i analog component video signal, the television or display device is responsible for decoding and blocking of incoming 480i signals in accordance with the user-defined content advisory settings. The technology for blocking unwanted content based on the content's rating is generally referred to as V-chip technology. For delivery of the television signal via a digital interface, such as via a High-Definition Multimedia Interface (HDMI) input, unlike the analog video case, it is the responsibility of the source device, not the display device, to perform this decoding and blocking functionality. This is due to the fact that an HDMI link carries only the video information and not the attendant parental control data which may accompany the digital source video signal. The same situation applies to digital signals carried through cable, satellite, over-the-air (OTA) and Internet Protocol TV (IPTV), where the carriage of content advisory data is different than with NTSC signals and where there is no standard mechanism for conveyance of the data through digital interfaces.

FIG. 1 shows a typical female HDMI interface 100 comprised of pins 1 through 19. While most of the HDMI interface 100 pins are actively used in video transmission, some of the pins have been reserved (e.g., pin 14), or otherwise not assigned a specific function at this time (e.g., pin 19).

As a result of the fact that content advisory data does not travel on uncompressed digital interfaces such as HDMI, and thus that each digital source device must decode content advisory data and perform the blocking function, users are currently faced with the cumbersome task of having to access a variety of different devices in order to set up and control the user's content advisory settings. A user must operate a number of different remote controls and access a variety of user menus/interfaces for each of the various connected devices (e.g., personal video recorders (PVRs), digital video disk (DVD) players, set-top boxes (STBs), etc.).

Thus, what is needed is a system and method for synchronizing parental control settings across a plurality of connected devices, including both source devices and sink devices to provide a comprehensive solution to managing the parental control settings across the many possible sources of digital video.

### BRIEF SUMMARY OF THE INVENTION

Disclosed and claimed herein are systems and methods for synchronizing content advisory settings. In one embodiment, a method includes receiving, by a display device, parental control settings from a user, generating a message based on the parental control settings, and transmitting the message to a source device over a high-definition multimedia interface (HDMI) connection. The method further includes receiving pre-filtered video content from the source device over the HDMI connection, where the pre-filtered video content has been processed by the source device using parental control data from the message.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a diagram of a typical HDMI connector and corresponding pin descriptions;

FIG. 2 is a block diagram of a system configured in accordance with one embodiment of the invention;

FIG. 3 depicts a graphical user interface for providing parental control settings in accordance with the invention;

FIG. 4 is one embodiment of a process for carrying out one or more aspects of the invention; and

FIG. 5 is another embodiment of a process for carrying out one or more aspects of the invention.

### DETAILED DESCRIPTION OF EXEMPLARY EMBODIMENTS

### Disclosure Overview

One aspect of the present disclosure relates providing parental control setting to a display device using, for example, a remote control device. As will be described in more detail below, the display device may then generate a message (such as a consumer electronic control (CEC) message) which corresponds to the received parental control settings. This message may then be transmitted to one or more source devices to which the display device is connected via an HDMI interface. In certain embodiments, the HDMI-connected devices may then receive and process this message and, in response thereto, modify or otherwise conform such device's parental control settings in accordance with the parent control data in the received message.

Thereafter, the display device may receive content from an HDMI-connected device which has already been pre-filtered (processed for parental control blocking and block as necessary) in accordance with the received parental control settings, as previously supplied via the message. In one embodiment, this filtering process may be performed by the source device using content advisory data present in the pre-filtered incoming source video. As used herein, the term “pre-filtered” may indicate the content advisory data accompanying the content has been checked against parental control settings, and audio/video output has been block if the ratings were found to exceed the established parental control settings.

Rather than having the display device broadcast or otherwise provide the parental control data to the various HDMI-connected device, another aspect of the invention relates to having the HDMI-connected source devices provide one or more messages to the display device which contains content advisory data for video content which is being provided (or about to be provided) to the display device over the HDMI connection. In this fashion, the display device receives unfiltered video content from the HDMI-connected device over an HDMI interface and the display device processes the unfiltered video content based on this content advisory data in accordance with the parental control setting previously provided by the user directly to the display device, blocking or un-blocking the viewing as appropriate.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

### Exemplary Embodiments

The present disclosure relates to the fact that most television systems are actually comprised of several source components with which the TV (i.e., the sink device) need to interface, including for example a STB, PVR, home theater (HT) system, etc.

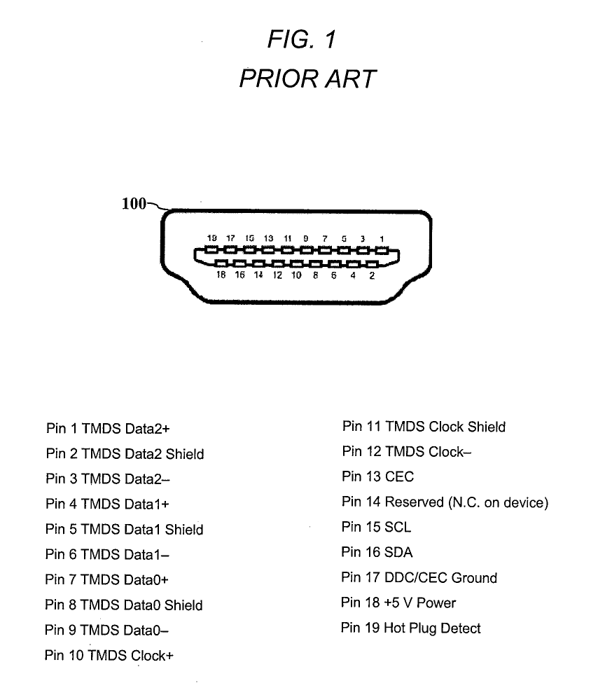

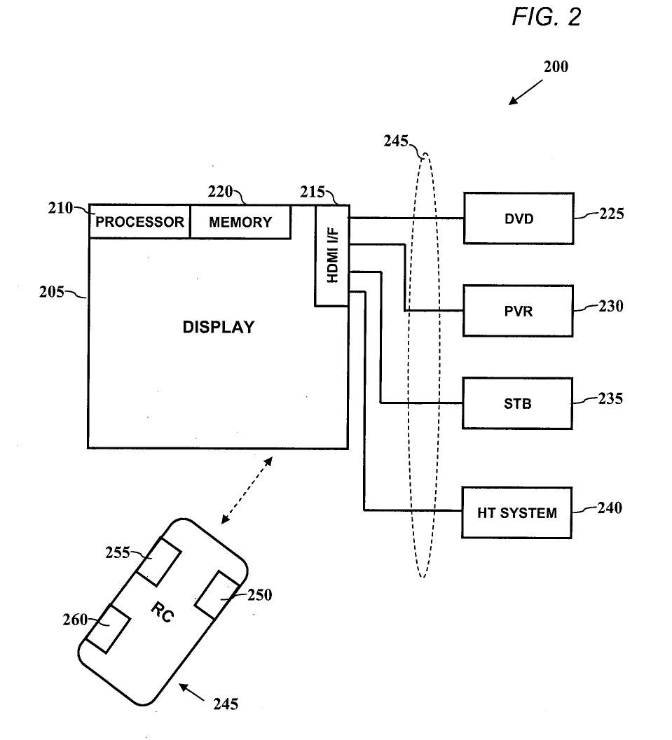

To that end, FIG. 2 depicts a system 200 configured in accordance with the principles of the invention. In particular, system 200 includes a sink device in the form of display 205 (e.g., television). The display 205 includes a processor 210, a memory 220 and an HDMI interface 215 having a plurality of input ports. In one embodiment, the HDMI interface 215 may be configured in accordance with the HDMI interface 100 of FIG. 1.

In one embodiment, the processor 210 is configured to decode content advisory data encoded in programming or packaged media (e.g., DVD) which is received by any input interface on the display 205. The processor 210 may also be configured with so-called V-chip technology in which access to certain categories of content (e.g., program-based or packaged) is blocked based on user-defined content advisory settings stored in memory 220, for example.

Continuing to refer to FIG. 2, display 205 may be electrically connected to one or more source devices, such as DVD 220, PVR 225, STB 230 and HT System 235. In one embodiment, each of the DVD 220, PVR 225, STB 230 and HT System 235 are coupled to the display 205 via HDMI connections 245.

Under the HDMI specification, there is an optional protocol referred to as the consumer electronic control (CEC) protocol. As fully defined in Supplement 1 of the HDMI Specification 1.3 (Jun. 22, 2006), the CEC protocol was designed to provide control functions between audio/video (A/V) devices that are connected via an HDMI cable. CEC assumes that all A/V source products in a system are directly or indirectly connected to a “root” display. In short, the CEC protocol is a one-wire, “party line” that connects up to ten source devices through standard HDMI cabling. The CEC protocol includes mechanisms for physical address discovery, logical addressing, arbitration, retransmission, broadcasting, and routing control.

One aspect of the present disclosure relates to the extension of the current CEC protocol messages to define signaling that allows synchronization or management of a user's parental control settings across, not only the user's television (e.g., display device 205), but also the user's various source devices (e.g., DVD 220, PVR 225, STB 230 and HT System 235). This is particularly helpful since, as previously mentioned, it is the responsibility of the individual source devices, and not the display device, to perform the parental setting decoding and blocking functionality for HDMI-connected systems.

In addition to the CEC protocol messaging which is provided over dedicated pins 13 and 17 (see FIG. 1), the HDMI specification further includes a display data channel (DDC) line, a Hot Plug Detect (HPD) line and a reserve line. To that end, parent control management messaging over the DDC line may be based on the Inter-Integrated Circuit (I²C) protocol. Similarly, such messaging may be readily provided over the HPD and reserve lines in accordance with any known communication protocol. While the CEC messaging may be preferred due to its bus-based architecture, the I²C protocol bus (e.g., over the DDC line) is a point-to-point protocol and may require the use of a repeater, amp and/or distributor—all of which would be consistent with the principles of the invention.

Continuing to refer to FIG. 2, the system 200 further includes a remote control device 245 having, in certain embodiments, an RF or IR transmitter 250 for sending remote commands in accordance with principles known in the art and also a remote control processor 255 connected to the various components of the remote control 245 for directing the remote control 245 to communicate via an RF band or IR band with the display device 205. Remote control 245 further includes a memory 260 for storing commands codes and the like, as is generally known.

It should further be appreciated that the remote control 245 may be configured to communicate with not only the display device 205, but also one or more of the various connected source devices (e.g., DVD 220, PVR 225, STB 230 and HT System 235). It should of course be understood that the remote control 245 may and likely does have additional components, such as a series of buttons or switches, a display, a power source, etc.

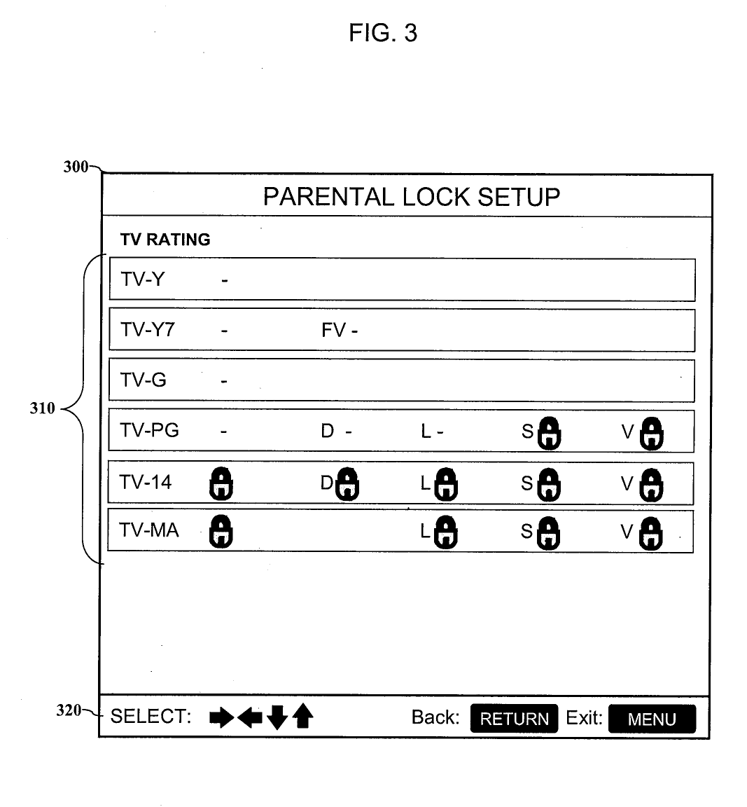

Referring now to FIG. 3, depicted is one embodiment of a graphical user interface (GUI) 300 usable to provide parental control setting data to a display device, such as display device 205. Using a remote control device (e.g., remote control 245), a user can navigate a list of possible parental control setting 310 using a navigation interface 320.

As shown in FIG. 3, TV ratings have various classifications that are abbreviated as follows: FV for fantasy violence; L for coarse language; S for sexual references and/or sex scenes; D for suggestive dialogue; and V for violence. Since the GUI 300 allows for selection of the individual classifications within a given TV rating, users may be able to specify that all programming having a particular TV rating be blocked (such as TV-14 and TV-MA in FIG. 3), or that only certain classifications within a given TV rating be blocked (such as TV-PG-S and TV-PG-V in FIG. 3). While such settings may represent the currently available parent control settings for broadcast and packaged video content in the United States, it should be appreciated that such setting may be different for other countries, or may be modified or replaced in the future and, as such, should not be interpreted as limiting the scope of the invention in any way. Moreover, it should be appreciated that there are many additional parental control settings available which have not been depicted in the GUI 300 of FIG. 3.

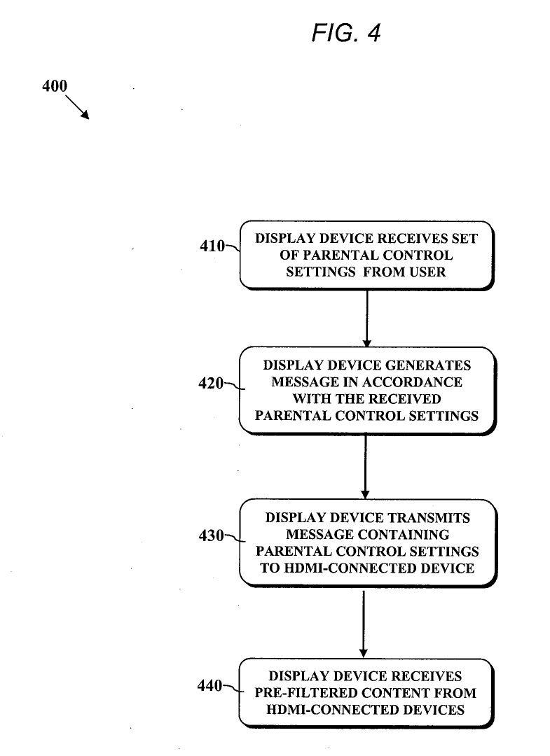

Referring now to FIG. 4, depicted is a process for carrying out one embodiment of the invention. In particular, process 400 begins at block 410 where a display device (e.g., display 205) receives parental control setting from a user. Such parent control settings may correspond to any one of the numerous possible setting, such as those depicted in FIG. 3 or otherwise. In one embodiment, such setting may be received using a remote control device, such as remote control device 245. Alternatively, the parental control setting may be provided using one or more buttons or switches of the display device. Regardless of the means by which the parental control setting are received, such information may then be stored in a local memory of the display device (e.g., memory 220) for later access.

Process 400 may then continue to block 420 where the display device may generate a message which corresponds to the received parental control settings of block 410. While the generated message may conform generally to the CEC protocol, it should be appreciated that the message structure (e.g., header blocks, data blocks, number of frames, etc.) may vary, as well as the message protocol (e.g., DDC/I²C). In one embodiment, the message generation is performed by a processor of the display device, such as processor 210.

Continuing to refer to FIG. 4, process 400 continues to block 430 where the display device may then transmit the message generated above at block 420 to one or more HDMI-connected devices (e.g., DVD 220, PVR 225, STB 230 and/or HT System 235). In this context, an HDMI-connected device is any source device which is connected to the display device via an HDMI interface. In one embodiment, the operation of block 430 may include the display device operating as a so-called “initiator” and the one or more HDMI-connected devices being the so-called “followers,” as generally described in the CEC protocol. Similarly, the message of block 430 may be sent to the addresses of only specific HDMI-connected devices, or may alternatively be broadcast over the CEC bus.

In the event that the message of block 430 is not a CEC message as described above, such message may be transmitted over the previously-described DDC line, the HPD line and/or the reserve line in accordance with the I²C protocol or any other known communication protocols consistent with the principles of the invention.

While not shown in the process 400 of FIG. 4, in one embodiment it is assumed that at least one HDMI-connected device will receive and process the message transmitted above at block 430. This may include modifying or otherwise conforming such device's parental control setting in accordance with the parent control data in the received message (which corresponds to the user-defined setting of block 410).

Process 400 may then continue to block 440 where the display device may receive pre-filtered video content from an HDMI-connected device over an HDMI interface (e.g., via HDMI connection 240). In this fashion, a single set of parental control settings may be provided to a display device and used to govern what video content is blocked, regardless of the source of the content and regardless of the fact that such content is provided by an HDMI-connected device.

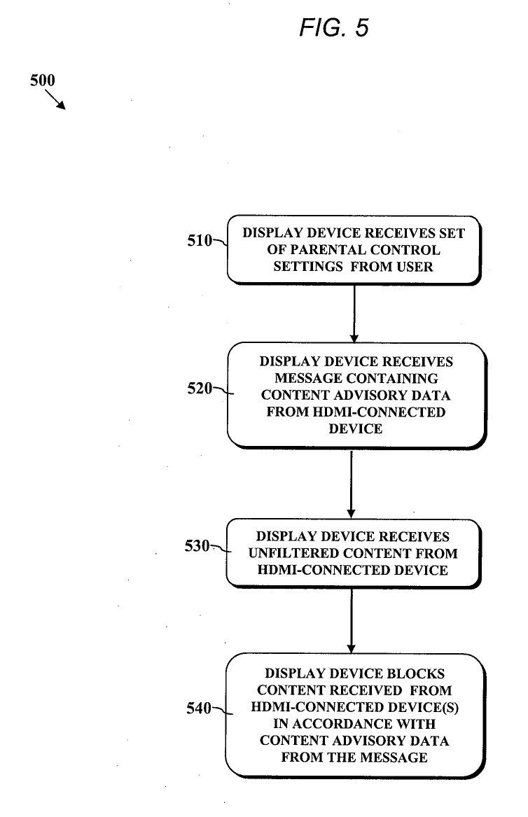

Referring now to FIG. 5, depicted is another embodiment of a process 500 for carrying out one or more aspects of the invention. In particular, process 500 begins at block 510 with the display device (e.g., display 205) receiving parental control settings from a user. As mentioned above with reference to FIG. 4, such settings may be received using a remote control device (e.g., remote control device 245), or may alternatively be provided using one or more buttons or switches of the display device. Regardless of the means by which the parental control settings are received, such information may then be stored in a local memory of the display device (e.g., memory 220) for later access.

Process 500 may then continue to block 520 where the display device may receive one or more messages from an HDMI-connected source device (e.g., DVD 220, PVR 225, STB 230 and/or HT System 235), and may correspond to the content advisory data for video content which is being provided (or about to be provided) to the display device over the HDMI connection. As with process 400, the receiving operation of block 520 may correspond to receiving one or more CEC-based messages generated, for example, by a processor of the corresponding source device. In one embodiment, the operation of block 520 may include the HDMI-connected device operating as a so-called “initiator” and the display device being the so-called “follower,” as generally described in the CEC protocol.

Alternatively, the operation performed at block 520 may correspond to receiving the one or more messages over the previously-described DDC line, the HPD line and/or the reserve line, whether such messages are formatted in accordance with the I²C protocol or any other known communication protocols consistent with the principles of the invention.

Continuing to refer to FIG. 5, process 500 continues to block 530 where the display device may then receive unfiltered video content from the HDMI-connected device over an HDMI interface (e.g., via HDMI connection 240). It should be appreciated that the unfiltered video content of block 530 may overlap with the receipt of the corresponding message(s) of block 420, or may be received anytime thereafter.

At this point, process 500 continues to block 540 where the display device will process the unfiltered video content of block 530 based on the content advisory data received via the message(s) of block 520, and in accordance with the parental control setting provided by the user at block 510. In this fashion, a single set of parental control settings may be provided to a display device and used to govern what video content is blocked, regardless of the source of the content and regardless of the fact that such content is provided by an HDMI-connected device.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for synchronizing parental control setting comprising:
receiving, by a display device, parental control settings from a user;
generating a message based on said parental control settings;
transmitting said message to a source device over a high-definition multimedia interface (HDMI) connection; and
receiving pre-filtered video content from the source device over the HDMI connection, wherein said pre-filtered video content has been processed by the source device using parental control data from said message.

2. The method of claim 1, wherein generating the message comprises generating the message in accordance with a consumer electronic control (CEC) protocol.

3. The method of claim 1, wherein transmitting said message comprises transmitting said message to the source device over one or more HDMI lines of said HDMI connection, wherein the HDMI lines are selected from the list consisting of: a display data channel (DDC) line, a consumer electronics control (CEC) line, a Hot Plug Detect (HPD) line and a reserve line.

4. The method of claim 1, wherein receiving the parental control settings comprises receiving the parental control settings from a user via a graphical user interface, and wherein the method further comprises displaying the graphical user interface in response to a user instruction.

5. The method of claim 1, wherein transmitting said message comprises broadcasting said message to a plurality of source devices electrically connected to the display device over the HDMI connection.

6. The method of claim 1, wherein said message is usable by the source device to modify a content blocking setting of said source device.

7. The method of claim 1, wherein the pre-filtered video content has been filtered by the source device in accordance with the parental control settings.

8. The method of claim 7, wherein the pre-filtered video content has been filtered by the source device using content advisory data corresponding to the pre-filtered video.

9. A display device comprising:
a display screen;
a high-definition multimedia interface (HDMI), wherein the HDMI is coupled to a source device forming an HDMI connection; and
a processor coupled to the HDMI and the display screen, wherein the processor is configured to,
receive parental control settings from a user,
generate a message based on said parental control settings,
transmit said message to a source device over the HDMI connection, and
receive pre-filtered video content from the source device over the HDMI connection, wherein said pre-filtered video content has been processed by the source device using parental control data from said message.

10. The display device of claim 9, wherein the processor is further configured to generate the message in accordance with a consumer electronic control (CEC) protocol.

11. The display device of claim 9, wherein the processor is further configured to transmit the message over one or more HDMI lines of the HDMI connection, wherein the HDMI lines are selected from the list consisting of: a display data channel (DDC) line, a consumer electronics control (CEC) line, a Hot Plug Detect (HPD) line and a reserve line.

12. The display device of claim 9, wherein the processor is further configured to receive the parental control settings from a user via a graphical user interface, and wherein the processor is to display the graphical user interface in response to a user instruction.

13. The display device of claim 9, wherein the processor is further configured to broadcast said message to a plurality of source devices electrically connected to the display device over the HDMI connection.

14. The display device of claim 9, wherein said message is usable by the source device to modify a content blocking setting of said source device.

15. The display device of claim 9, wherein the pre-filtered video content has been filtered by the source device in accordance with the parental control settings.

16. The display device of claim 15, wherein the pre-filtered video content has been filtered by the source device using content advisory data corresponding to the pre-filtered video.

17. A method for synchronizing parental control setting comprising:
receiving, by a display device, parental control settings from a user;
receiving, from a source device over a high-definition multimedia interface (HDMI) connection, a message containing content advisory data for incoming video content;
receiving the incoming video content from the source device over the HDMI connection;
filtering said incoming video content in accordance with the content advisory data from the message and the parental control settings.

18. The method of claim 17, wherein receiving the message comprises receiving the message prior to said receiving the incoming video content.

19. The method of claim 17, wherein the message corresponds to a consumer electronic control (CEC) protocol.

20. The method of claim 17, wherein receiving the message further comprises receiving the message over one or more HDMI lines of the HDMI connection, wherein the HDMI lines are selected from the list consisting of: a display data channel (DDC) line, a consumer electronics control (CEC) line, a Hot Plug Detect (HPD) line and a reserve line.
